(19) United States
(12) Patent Application Publication
(10) Pub. No.: US 2006/0279165 A1
(43) Pub. Date: Dec. 14, 2006

(54) Alternator rotor core

(75) Inventors: David A. Fulton, Anderson, IN (US); Keith Yeager, Fishers, IN (US)

Correspondence Address: Thomas A. Walsh;Ice Miller, One Indiana Square, Box 82001, Indianapolis, IN, 46282-0200, US

(73) Assignee: Remy International, Inc. a Delaware corporation, Anderson, IN (US)

(21) Appl. No.: 11/151,970

(22) Filed: Jun. 14, 2005

(51) Int. Cl. H02K 31/00

(52) U.S. Cl. 310/263

(57) ABSTRACT

An improved alternator rotor comprising a nonhomogenous steel rotor core, the nonhomogenous steel rotor core comprising a low carbon inner portion and a high carbon outer portion around the low carbon inner portion. An improved alternator rotor comprising a steel rotor core of nonhomogenous hardness, wherein an outer portion of the steel rotor core is harder than an inner portion of the steel rotor core.

### BACKGROUND

A conventional alternating current generator, or “alternator,” such as the type used in conjunction with an internal combustion engine in a motor vehicle, comprises a rotor, a rotor winding (also known as a field winding), a stator, one or more stator windings, a rectifier bridge, and a set of field diodes.

The rotor typically comprises a rotor core and a field winding around the rotor core. The rotor is rotated within the stator, typically by the action of the engine in the motor vehicle in which the alternator is installed. As the rotor rotates within the stator, an electric current passing through the field winding produces a magnetic field. As the rotor rotates, the magnetic field also rotates.

The stator typically surrounds the rotor and holds the stator windings. The stator windings usually (but not always) consist of three individual sets of windings connected in a delta or wye configuration. As the magnetic field produced by the field winding turns, it cuts through each set of windings of the stator thereby inducing an alternating electric current.

The rectifier bridge is electrically connected to the stator windings. The rectifier bridge converts the alternating current produced by the stator windings into direct current that is useable to charge the motor vehicle battery (if present) and to supply other electric loads.

In a motor vehicle application, a battery typically is connected in parallel with outputs of the rectifier bridge to deliver adequate electric current to any electric loads when the field winding is not rotating, or when the field winding is rotating too slowly to result in a voltage equal to the battery voltage, or when the field winding is rotating but the electric loads exceed the maximum current output from the alternator. When the field winding rotates at an increased speed, a voltage results across the battery terminals that is greater than the battery voltage, and the battery thereby is re-charged.

The field diodes operate in a fashion similar to the rectifier bridge, except these diodes convert the alternating current produced by the stator into direct current that is useable by the field winding. Thus, the alternator can supply its own current to the field winding. This process is called “self excitation.”

When the rotor is started from a resting state, many alternators must rely on residual magnetism in the rotor core to build up the main field in the alternator to the point where the alternator is generating enough electricity for self-excitation to occur. The minimum speed at which the residual magnetism builds up the field to the point of self-excitation is called the “turn-on” speed and is usually measured in rotor revolutions per minute.

The rotor core performs two main functions in an alternator: (i) it carries the magnetic flux inside the alternator; and (ii) it acts as a permanent magnet to provide residual magnetism to generate electricity until the point of self-excitation. Generally, these two functions are in conflict with each other, as there are no low cost materials that accomplish both of these functions well. Low carbon steels typically carry magnetic flux efficiently, while hardened high carbon steels typically have good permanent magnet properties. The choice of rotor core material is usually a compromise between flux carrying properties and permanent magnet properties. Typically, medium carbon steel is chosen. The B-H curve for medium carbon steel has fairly good permanent magnet properties (high Bᵣ and H_{c}). However, it has a fairly low saturation flux density (Bₛₐₜ) and permeability. Permeability is defined as a change in magnetic induction (ΔB) for a given change in magnetic field (ΔH). Since Bₛₐₜ and permeability are low, the cross-sectional area of a rotor core constructed from medium carbon steel must be large. Otherwise, there will be a large magnetomotive force (MMF) drop across the rotor core. A large MMF drop in the rotor core reduces the overall electrical output of the alternator. However, a large rotor core has disadvantages including weight, size, and mass moment of inertia. In addition, the overall size and configuration of the alternator typically are driven by the size of the rotor core. Thus, a larger rotor core means a larger alternator.

For the foregoing reasons, it is desired to provide a rotor core having the characteristics of high permeability, high saturation flux density, and high residual magnetism. Such a rotor core will enable a reduction in rotor core weight, size, and mass moment of inertia without a loss of performance efficiency. The overall size and configuration of the alternator typically are driven by the size of the rotor core, so reducing the size of the rotor core allows the alternator dimensions and weight to be reduced. Alternatively if a reduction in rotor core size is not desired, improving the characteristics of permeability, saturation flux density, and residual magnetism will provide enhanced rotor core performance compared to a prior art rotor core of an equivalent size.

### SUMMARY

In an embodiment, the present invention comprises an alternator having a stator and a rotor rotatable within the stator. The rotor comprises a nonhomogenous steel rotor core, the nonhomogenous steel rotor core comprises a low carbon steel inner portion and a high carbon steel outer portion around the low carbon steel inner portion. In an aspect of this embodiment, the low carbon steel inner portion comprises a carbon percentage of less than about 0.2%. In an aspect of this embodiment, the high carbon steel outer portion comprises a carbon percentage of between about 0.6% and about 1.0%. In an aspect of this embodiment, the high carbon steel outer portion is hardened.

In an embodiment, the present invention comprises an alternator having a stator and a rotor rotatable within the stator. The rotor comprises a steel rotor core of nonhomogenous hardness, the steel rotor core of nonhomogenous hardness comprises an inner portion and an outer portion, wherein the outer portion is harder than the inner portion. In an aspect of this embodiment, the steel rotor core comprises a medium carbon steel. In an aspect of this embodiment, the steel rotor core comprises a carbon percentage of between about 0.4% and about 0.5%.

In an embodiment, the present invention comprises a method for improving the residual magnetism of an alternator rotor core without changing its geometry. The method comprises the steps of providing a low carbon steel rotor core, and adding carbon to a surface of the low carbon steel rotor core. In an aspect of this embodiment, the present invention comprises the step of hardening the surface of the low carbon steel rotor core. In an aspect of this embodiment, the step of adding carbon to a surface of the low carbon steel rotor core comprises the step of carburizing the surface.

In an embodiment, the present invention comprises a method for improving the performance of an alternator by utilizing a nonhomogenous steel rotor core. In an aspect of this embodiment, the nonhomogenous steel rotor core comprises a low carbon steel inner portion and a high carbon steel outer portion around the low carbon steel inner portion. In an aspect of this embodiment, the nonhomogenous steel rotor core comprises an inner portion and an outer portion, the outer portion being harder than the inner portion.

### BRIEF DESCRIPTION OF THE DRAWINGS

The features and advantages of this invention, and the methods of obtaining them, will be more apparent and better understood by reference to the following descriptions of embodiments of the invention, taken in conjunction with the accompanying drawings, wherein:

FIG. 1 shows a cross-sectional view of an alternator according to the prior art;

FIG. 2 shows a cross-sectional view of the prior art alternator of FIG. 1, illustrating the useful flux path;

FIG. 3A shows the equivalent magnetic circuit for the flux path shown in FIG. 2, where no current supplied to the field coil and the only flux is produced by the residual magnetism in the rotor core;

FIG. 3B shows the demagnetization curves for high carbon and hardened steel and low carbon steel;

FIG. 4 shows an electric schematic comprising an alternator excitation circuit according to the prior art; and

FIG. 5 shows a cross-sectional view of an alternator according to the present invention.

### DESCRIPTION

The present invention comprises an alternator having a rotor core with improved permeability, saturation flux density, and residual magnetism compared to prior art rotor cores. For the purposes of promoting an understanding of the principles of the present invention, reference will now be made to the embodiment illustrated in the drawings, and specific language will be used to describe the same. It will nevertheless be understood that no limitation of the scope of the invention is thereby intended.

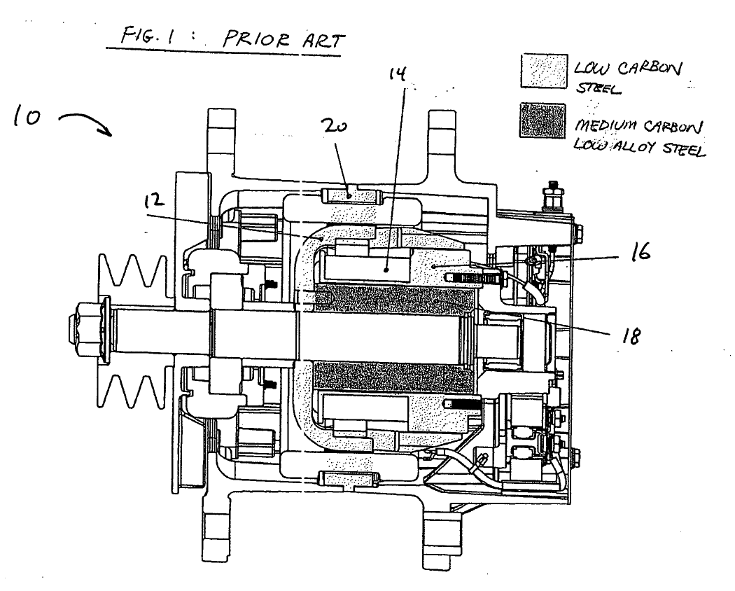

FIG. 1 shows a cross-sectional view of alternator 10 according to the prior art. Alternator 10 is a brushless Lundell (claw-pole type) alternator comprising claw-pole segments 12, field winding 14, field winding support 16, rotor core 18, and stator 20. Claw-pole segments 12, field winding support 16 and rotor core 18 comprise a low-carbon steel of less than about 0.2% carbon. Rotor core 18 is generally cylindrical in shape and comprises a medium-carbon steel of about 0.4%-0.5% carbon.

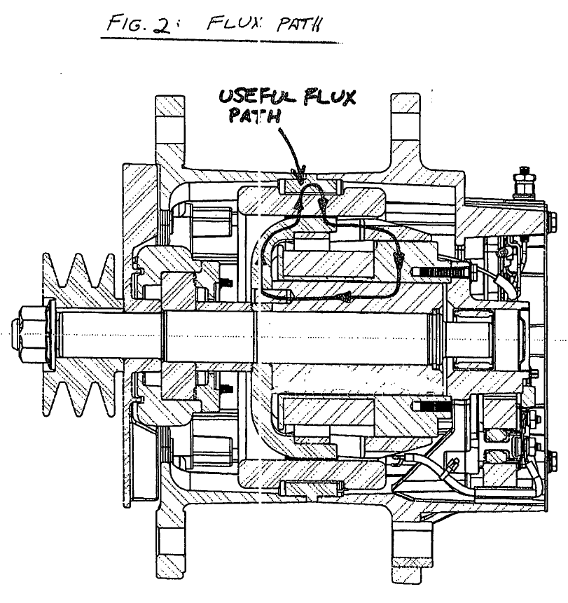

FIG. 2 shows a cross-sectional view of alternator 10 illustrating the useful flux path. The useful flux path comprises a closed loop that travels through rotor claw-pole segments 12, field winding support 16, rotor core 18, and stator 20.

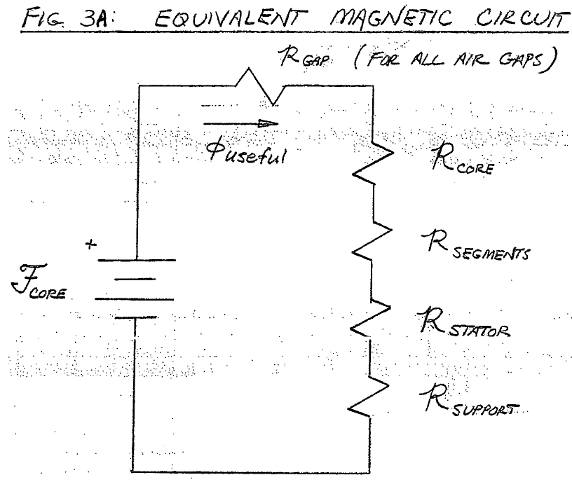

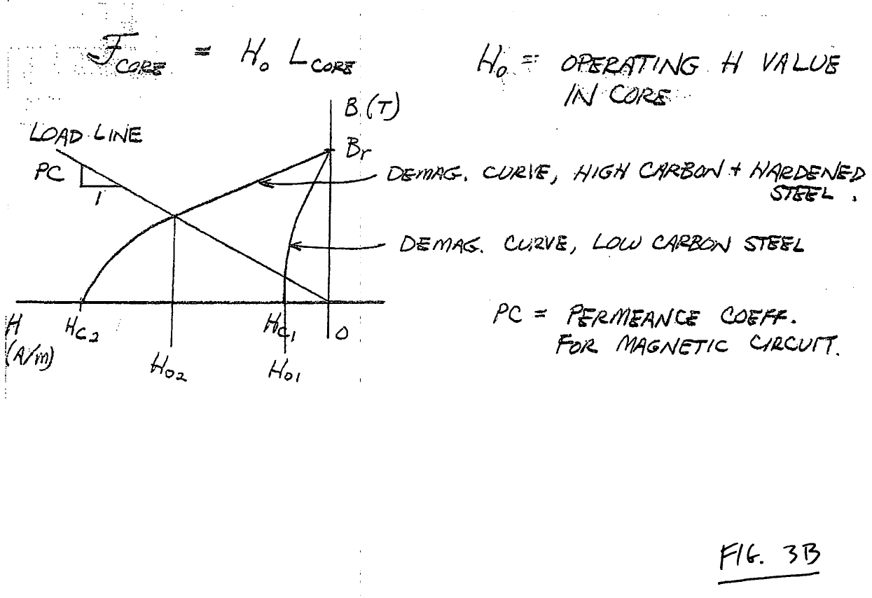

FIG. 3A shows the equivalent magnetic circuit for the flux path shown in FIG. 2, where no current supplied to the field coil and the only flux is produced by the residual magnetism in the rotor core. Shown in FIG. 3A are the MMF of the rotor core, F_{core}, and the respective reluctances of claw-pole segments 12 (R_{segments}), field coil support 16 (Rₛᵤₚₚₒᵣₜ) rotor core 18 (R_{core}), stator 20 (Rₛₜₐₜₒᵣ), and any air gaps separating the components (R_{gap}). The useful flux (Φᵤ) in this magnetic circuit is calculated Φᵤ=F_{core}/(R_{core}+R_{segments}+Rₛₜₐₜₒᵣ+Rₛᵤₚₚₒᵣₜ+R_{gap}). F_{core} is equivalent to Hₒ*L_{core}, where Hₒ is the magnetic field intensity in the rotor core and L_{core} is the effective axial length of the rotor core. The value of Hₒ depends on the magnetic properties of the rotor core and the permeance coefficient of the flux path. FIG. 3B shows the demagnetization curves for high carbon and hardened steel and low carbon steel. As shown in FIG. 3B, if Bᵣ and the permeance coefficient are held constant, Hₒ increases as the coercivity of the rotor core increases. In turn, the rotor core MMF increases, and so does the useful flux Φᵤ.

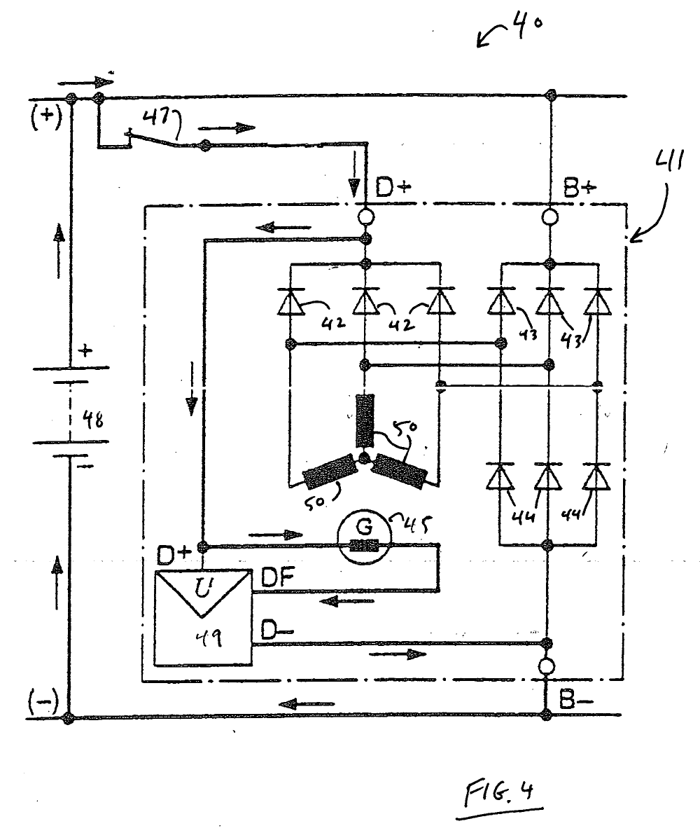

FIG. 4 shows an electric schematic 40 comprising an alternator excitation circuit. Shown in FIG. 4 are alternator 41 comprising field diodes 42, positive diodes 43, negative diodes 44, field winding 45, voltage regulator 46, and three sets of stator windings 50. Also shown in FIG. 4 are ignition switch 47 and battery 48. The voltage generated by the stator windings 50 is proportional to the useful flux Φᵤ in the magnetic circuit and the speed with which the rotor (not shown) rotates. The alternator “turns on” or becomes “self-excited” when the voltage generated by the stator windings 50 exceeds the field diode voltage drop in the excitation circuit. Where the alternator is deployed in conjunction with an internal combustion engine, it is essential that the rotational speed of an alternator rotor is high enough, after the internal combustion engine is started, to turn on the alternator. In addition, electric current output requirements for the alternator impose minimum requirements for useful flux Φᵤ after the alternator turns on, i.e., as current is supplied to the field coil. In operating mode (i.e., during self-excitation), the useful flux is Φᵤ=F_{coil}/(R_{core}+R_{segments}+Rₛₜₐₜₒᵣ+Rₛᵤₚₚₒᵣₜ+R_{gap}) where F_{coil}=(amps in field coil*no. of turns in coil). The reluctance of the rotor core is R_{core}=L_{core}/(P_{core}*A_{core}), where L_{core} is the effective axial length of the rotor core, P_{core}=rotor core permeability, and A_{core}=cross-sectional rotor core area in a plane perpendicular to rotor core's longitudinal axis. The rotor core size and material must be chosen so as to carry the necessary magnetic flux before and after current is supplied to the field coil, i.e., in both the start-up and operating modes. For a given amount of operating mode flux, higher rotor core permeability P_{core} allows use of a smaller rotor core diameter A_{core}.

The present invention comprises a nonhomogenous rotor core wherein the surface of the rotor core possesses permanent magnet properties that equal or exceed those of prior art medium carbon rotor cores, and the interior of the rotor core possesses permeability that equals or exceeds those of a prior art medium carbon rotor core.

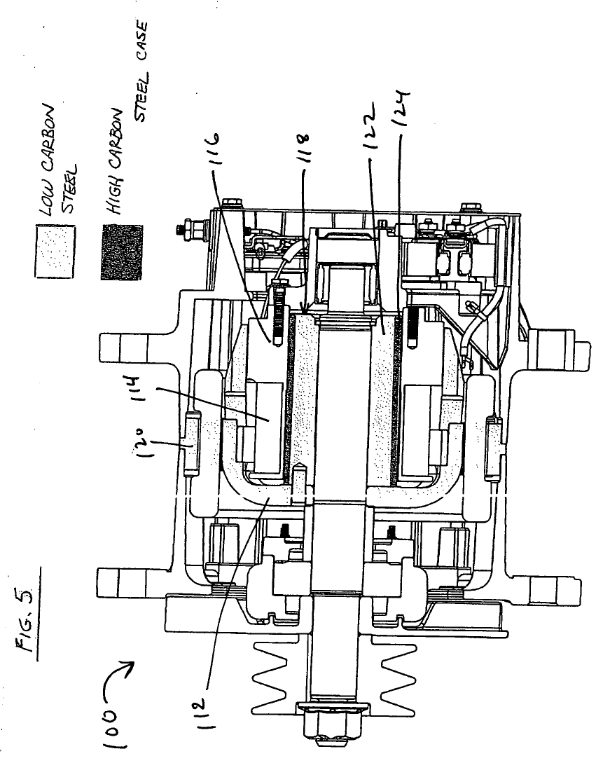

FIG. 5 shows a cross-sectional view of an alternator 100 according to the present invention. Alternator 100 is a brushless Lundell (claw-pole type) alternator comprising claw-pole segments 112, field winding 114, field winding support 116, rotor core 118, and stator 120. Claw-pole segments 112, field winding support 116, and rotor core 118 comprise a low-carbon steel of less than about 0.2% carbon. Rotor core 118 is Generally cylindrical in shape and comprises a generally cylindrical inner layer 122 and a generally cylindrical outer layer 124 surrounding the inner layer 122. The useful flux path of alternator 100 is essentially the same as the useful flux path shown in FIG. 2.

In an embodiment of the present invention, rotor core 118 comprises a low carbon steel such as, for example, a steel with no more than 0.2% carbon. The low carbon steel rotor core has a higher Bₛₐₜ than the medium carbon steels typically used in rotor cores according to the prior art. Therefore, at a given field coil MMF, a low carbon steel rotor core provides more useful flux when compared to the useful flux provided by medium-carbon steel rotor cores according to the prior art. However, a low carbon steel rotor core is a less effective permanent magnet than a medium-carbon steel rotor core. According to an embodiment of the present invention, the carbon is added to the surface of rotor core 118 to create a high carbon outer layer 124. After carbon is added to the surface of rotor core 118, outer layer 124 comprises a high carbon content such as, for example, a carbon content in the range of about 0.6% carbon to about 1.0% carbon, while the carbon content of the inner layer 122 comprises a low carbon content such as, for example, a carbon content of no more than 0.2% carbon. The permanent magnet properties of high carbon outer layer 124 of rotor core 118 exceed the permanent magnet properties of medium-carbon steel rotor cores according to the prior art. The low carbon inner layer 122 retains the permeability and higher saturation flux density of a low carbon steel.

Carbon is added to rotor core 118 to create outer layer 124 according to methods known in the art. For example, carbon can be added to rotor core 118 to create outer layer 124 by the technique of carburization or another carbon enhancing technique known in the art. A carburized rotor core 118 also can be hardened by quenching rotor core 118 in oil or water after carburizing using techniques known in the art.

It may not be optimal to have a hardened high carbon layer over the entire rotor core. For example, rotor core 118 would not benefit from such a layer on the axial end in contact with the claw pole segments 112. All of the useful flux would pass through this axial end layer, resulting in an undesirable MMF drop across this layer due to high carbon steel's low permeability and tendency towards saturation (i.e., low Bₛₐₜ value). This condition can be avoided, if desired, by one of the following methods: (i) selectively carburizing the rotor core surface, (ii) selectively remove the high carbon layer from the rotor core surface by machining, or (iii) selectively hardening the carburized layer of the rotor core surface.

The rotor core can be selectively carburized by “masking off” areas where carburization is not desired with copper plating before carburizing. The entire part then may be quenched and tempered, or merely the carburized areas may be hardened by induction or flame hardening or by another hardening technique known in the art.

Alternatively, the part can be carburized over its entire surface area, slow cooled, and then selectively machined to remove the carburized layer where desired. The entire part then may be quenched and tempered, or merely the carburized areas may be hardened by induction or flame hardening or by another hardening technique known in the art.

Alternately, the part can be slow-cooled after carburizing, resulting in a high carbon but low hardness layer. Surfaces may then be selectively hardened by induction or flame hardening or by another hardening technique known in the art. Surfaces that are not hardened will still have high carbon, but the magnetic properties will be much closer to unhardened medium carbon steel.

In an embodiment of the present invention, rotor core 118 comprises a medium carbon steel such as, for example, a steel with about 0.4% to about 0.5% carbon. According to this embodiment of the present invention, the surface of rotor core 118 is hardened such as, for example, by induction hardening or flame hardening, or by another hardening technique known in the art. After hardening, rotor core 118 comprises a hardened outer layer 124 and a substantially unchanged inner layer 122. The permanent magnet properties of hardened outer layer 124 of rotor core 118 exceed the permanent magnet properties of medium-carbon steel rotor cores according to the prior art. In an embodiment, a rotor core constructed of 1045 steel can be hardened to an effective case depth of between about 0.020″ and about 0.110″ with Rockwell C hardness of at least about 50 through the effective case depth. In a particular implementation, an effective case depth of 0.060″ is employed.

It is noted that although FIGS. 1-5 show a brushless Lundell alternator, the present invention may be implemented in a brush-type alternator as well.

It is noted that although the term “layer” is used herein in discussing the nonhomogeneous rotor core of the present invention, this term should not be interpreted to necessarily mean discrete strata. Instead, because an outer layer of a rotor core according to the present invention can be created by adding carbon to the low carbon material comprising the rotor core, it will be appreciated that there will often be a transitional range between the higher carbon and lower carbon portions of a rotor core according to the present invention. Likewise, because an outer layer of a rotor core according to the present invention can be created by hardening to the material comprising the rotor core, it will be appreciated that there will often be a transitional range between the hardened and unhardened portions of a rotor core according to the present invention.

The present invention provides a rotor core having the characteristics of high permeability, high saturation flux density, and high residual magnetism. Such a rotor core enables a reduction in rotor core weight, size, and mass moment of inertia without a loss of performance efficiency. Because the overall size and configuration of the alternator typically are driven by the size of the rotor core, reducing the size of the rotor core allows the alternator dimensions and weight to be reduced. Alternatively, if a reduction in rotor core size is not desired, the improved characteristics of permeability, saturation flux density, and residual magnetism provided in a rotor core according to the present invention provide enhanced performance compared to a prior art rotor core of an equivalent size.

While this invention has been described as having a preferred design, the present invention can be further modified within the scope and spirit of this disclosure. This application is therefore intended to cover any variations, uses, or adaptations of the invention using its general principles. Each such implementation falls within the scope of the present invention as disclosed herein and in the appended claims. Furthermore, this application is intended to cover such departures from the present disclosure as come within known or customary practice in the art to which this invention pertains and which fall within the limits of the appended claims.

We claim:

1. An alternator comprising:
a stator; and
a rotor positioned within said stator, said rotor comprising a nonhomogenous steel rotor core, said nonhomogenous steel rotor core comprising a low carbon steel inner portion and a high carbon steel outer portion around said low carbon steel inner portion.

2. The alternator of claim 1, wherein said low carbon steel inner portion comprises a carbon percentage of less than about 0.2%.

3. The alternator of claim 1, wherein said high carbon steel outer portion comprises a carbon percentage of between about 0.6% and about 1.0%.

4. The alternator of claim 1, wherein said high carbon steel outer portion is hardened.

5. An alternator comprising:
a stator; and
a rotor positioned within said stator, said rotor comprising a steel rotor core of nonhomogenous hardness, said steel rotor core comprising an inner portion and an outer portion, wherein said outer portion is harder than said inner portion.

6. The alternator of claim 5, wherein said steel rotor core comprises a medium carbon steel.

7. The alternator of claim 5, wherein said steel rotor core comprises a carbon percentage of between about 0.4% and about 0.5%.

8. A method for improving the residual magnetism of an alternator rotor core without changing its geometry, the method comprising the steps of:
providing a low carbon steel rotor core; and
adding carbon to a surface of said low carbon steel rotor core.

9. The method of claim 8, further comprising the step of:
hardening said surface of said low carbon steel rotor core.

10. The method of claim 8, wherein the step of adding carbon to a surface of said low carbon steel rotor core comprises the step of:
carburizing said surface.

11. The method of claim 10, wherein the step of adding carbon to a surface of said low carbon steel rotor core comprises, before the step of carburizing said surface, the step of:
masking said surface in areas where additional carbon is not desired.

12. The method of claim 10, wherein the step of adding carbon to a surface of said low carbon steel rotor core comprises, after the step of carburizing said surface, the step of:
machining said surface in areas where additional carbon is not desired.

13. A method for improving the performance of an alternator of the type comprising a stator and a rotor positioned within the stator, the method comprising the step of:
utilizing a nonhomogenous steel rotor core.

14. The method of claim 13, wherein said nonhomogenous steel rotor core comprises a low carbon steel inner portion and a high carbon steel outer portion around said low carbon steel inner portion.

15. The method of claim 13, wherein said nonhomogenous steel rotor core comprises an inner portion and an outer portion, said outer portion being harder than said inner portion.
